(19) United States
(12) Patent Application Publication
(10) Pub. No.: US 2026/0303453 A1
(43) Pub. Date: Oct. 1, 2026

(54) METHOD, DEVICE, AND MEDIUM FOR SERVICE PROFILE EVENT CONFIGURATION SERVICE

(71) Applicant: Verizon Patent and Licensing Inc., Basking Ridge, NJ (US)

(72) Inventors: Shanthala Kuravangi-Thammaiah, Keller, TX (US); Sudhakar Reddy Patil, Flower Mound, TX (US)

(21) Appl. No.: 19/096,800

(22) Filed: Apr. 1, 2025

(51) Int. Cl. H04L 41/0823; H04W 8/18

(52) U.S. Cl. CPC H04L 41/0836; H04W 8/18

(57) ABSTRACT

A method, a network device, and a non-transitory computer-readable storage medium are described in relation to a service profile event configuration service. The service profile event configuration service may be implemented for a network device, such as a core device of a core network. The service profile event configuration service may provide that user subscription profile or data includes a service profile that supports a service. The service may be a new service or an enhancement relative to services provided by core device functionality according to a network standard. The service profile event configuration service may enable a decoupling of the service from network standardized functionality and enable independent service evolution. The service profile may be implemented according to various schema.

### BACKGROUND

Development and design of networks present certain challenges from a network-side perspective and an end device perspective. For example, the evolution towards Sixth Generation (6G) networks and beyond in view of artificial intelligence (AI) introduces challenges that enable network functions to accommodate service and performance progression.

### BRIEF DESCRIPTION OF THE DRAWINGS

FIG. 1 is a diagram illustrating an exemplary environment in which an exemplary embodiment of a service profile event configuration service may be implemented;

FIG. 2A is a diagram illustrating an exemplary environment in which an exemplary embodiment of the service profile event configuration service may be implemented;

FIGS. 2B and 2C are diagrams illustrating an exemplary user subscription profile of an exemplary embodiment of the service profile event configuration service;

FIGS. 2D and 2E are diagram illustrating an exemplary process of an exemplary embodiment of the service profile event configuration service;

FIG. 2F is a diagram illustrating another exemplary environment in which an exemplary embodiment of the service profile event configuration service may be implemented;

FIG. 3 is a diagram illustrating exemplary components of a device that may correspond to one or more of the devices illustrated and described herein; and

FIG. 4 is a flow diagram illustrating an exemplary process of an exemplary embodiment of the service profile event configuration service.

### DETAILED DESCRIPTION

The following detailed description refers to the accompanying drawings. The same reference numbers in different drawings may identify the same or similar elements. Also, the following detailed description does not limit the invention.

The development and design of future generation networks, such as Fifth Generation (5G) Advanced networks, 6G networks and beyond may require the evolution of service plane functionality, core network functions, user subscription profiles, routing, and use of AI, among other types of network-related elements. These and other factors may hinder the deployment of future generation networks as software development may become a bottleneck to service providers, network operators, and the like, as well as enabling the interworking between 5G networks and future generation networks.

Current frameworks for network functions, such as those in a 5G core network provide all of the functionality and features to be implemented. As a consequence, the network functions may not be easily extended or influenced to accommodate new services. Additionally, the introduction of new services via software upgrades and updates of current core networks may accidentally jeopardize existing network services due to bugs and the like.

According to exemplary embodiments, a service profile event configuration (SPEC) service is described. According to an exemplary embodiment, the service profile event configuration service may enable the decoupling of standardized network functionality of network devices from new or enhanced services, features, network procedures, or the like (also referred to herein as a “pluggable service”). For example, the service profile event configuration service may decouple the software or other form of configuration, which may provide standardized core network functionality, from a service layer logic that may provide the pluggable service and the like. In view of this approach, the service profile event configuration service may provide independent feature evolution and streamline new services, enhancements, and the like.

According to an exemplary embodiment, the service profile event configuration service may be implemented with 5G core network devices, enhanced or advanced 5G core network devices, 6G core network devices, and other future generation core network devices. According to an exemplary embodiment, the service profile event configuration service may be implemented in dual core networks (e.g., 5G+6G, 5G Advanced and 6G, etc.) and in internetworking contexts (e.g., 5G core network interworking with 6G core network, etc.).

According to an exemplary embodiment, the service profile event configuration service may enable pluggable services for various network devices based on a service profile event configuration associated with a user subscription profile or the like. According to another exemplary embodiment, the service profile event configuration service may enable pluggable services for various network devices based on a centralized AI driven service logic, as described herein.

According to an exemplary embodiment, the service profile event configuration service may provide network services and features by defining a combination of event/trigger conditions, routing applets, service characteristics, looped SPECs, and priorities, or a sub-combination thereof, as described herein.

According to an exemplary embodiment, user profiles may be provisioned with SPEC identities or a complete SPEC, as described herein. For example, the service profile event configuration service may provide that the user subscription profile includes various service profiles. According to an exemplary embodiment, the service profile may correlate to a particular data instance or category of the user subscription data to which the service profile pertains. By way of example, access and mobility management data, which may be included in the user subscription profile, may correlate to a service profile that provides a service profile event configuration pertaining to access and mobility management associated with a user or end device. According to an exemplary embodiment, the service profile may include one or multiple SPEC identifiers, as described herein.

According to an exemplary embodiment, a network device may identify and select the service profile that enables the network device to perform a network procedure or a workflow in accordance with the service profile event configuration of the service profile, as described herein. In some instances, depending on the substance of the SPEC, the SPEC may include looped data in which one or multiple other SPECs may be called to enable performance of a chained network service.

In view of the foregoing, the service profile event configuration service may provide a streamlined approach for configuring and enhancing network devices with new or enhanced features and services. The service profile event configuration service may further enable independent evolution of configurations and new or enhanced features and services without hindering or disrupting essential or standardized functionality provided by the network devices. The service profile event configuration service may cooperatively interact and/or interface with the logic that provides the standardized functionality and support a dynamic range of new and enhanced services or features (e.g., simple services, chained services, etc.), prioritized operations, targeted triggering events, and the like, as described herein.

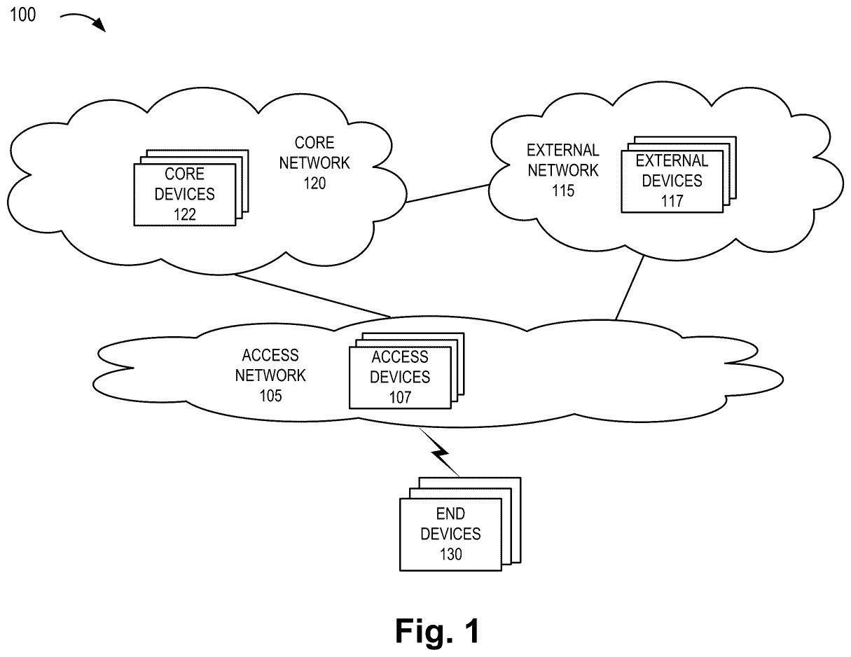

FIG. 1 is a diagram illustrating an exemplary environment 100 in which an exemplary embodiment of service profile event configuration service may be implemented. As illustrated, environment 100 includes an access network 105, an external network 115, and a core network 120. Access network 105 includes access devices 107 (also referred to individually or generally as access device 107). External network 115 includes external devices 117 (also referred to individually or generally as external device 117). Core network 120 includes core devices 122 (also referred to individually or generally as core device 122). Environment 100 further includes end devices 130 (also referred to individually or generally as end device 130).

The number, type, and arrangement of networks illustrated in environment 100 are exemplary. For example, according to other exemplary embodiments, environment 100 may include fewer networks, additional networks, and/or different networks. For example, according to other exemplary embodiments, other networks not illustrated in FIG. 1 may be included, such as an X-haul network (e.g., backhaul, mid-haul, fronthaul, etc.), a transport network (e.g., Signaling System No. 7 (SS7 ), an optical network, a wired network, etc.), a time-sensitive network (TSN) system, a deterministic networking (DetNet) network, or another type of network that may support a wireless service and/or an application service, as described herein.

A network device, a network element (NE), or a network function (NF) (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into distinct types of network architectures (e.g., Software Defined Networking (SDN), virtual, logical, etc.), as well as used to support other types of network elements (e.g., network slices, quality of service (QoS) flows, packet data unit (PDU) sessions, channels, network paths, tunnels, etc.). The number, the type, and the arrangement of network devices are exemplary.

Environment 100 includes communication links between the networks and between the network devices. Environment 100 may be implemented to include wired, optical, and/or wireless communication links. A communicative connection via a communication link may be direct or indirect. For example, an indirect communicative connection may involve an intermediary device and/or an intermediary network not illustrated in FIG. 1. A direct communication connection may not involve an intermediary device and/or an intermediary network. The number, type, and arrangement of communication links illustrated in environment 100 are exemplary.

Environment 100 may include various planes of communication including, for example, a control plane, a user plane, a service plane, a network management plane, an artificial intelligence and/or a machine learning (AI/ML) (control) plane, and a future generation plane, or a subset thereof. Environment 100 may include other types of planes of communication. A message communicated in support of the service profile event configuration service may use at least one of these planes. For example, the message of an exemplary embodiment of service profile event configuration service may use the control plane. According to various exemplary implementations, the interface of the network device may be a service-based interface (SBI), a reference point-based interface, an Open Radio Access Network (O-RAN) interface, a 5G interface, another generation of interface (e.g., 5G Advanced, 6G, 7G, 4G, etc.), or some other type of network interface (e.g., proprietary, etc.).

Access network 105 may include one or multiple networks of one or multiple types and technologies. For example, access network 105 may be implemented to include a terrestrial network, a non-terrestrial network (e.g., a satellite network, an air-based network, etc.), or a combination thereof. By way of further example, access network 105 may include a 5G RAN, a future generation RAN (e.g., a 6G RAN, a 7G RAN, or a subsequent generation RAN), a centralized-RAN (C-RAN), an O-RAN, and/or another type of access network. Access network 105 may include a legacy RAN (e.g., a Third Generation (3G) RAN, a 4G or 4.5 RAN (Long Term Evolution (LTE) Advanced (LTE-A), LTE Advanced Pro (LTE-A Pro), etc.). Access network 105 may communicate with and/or include other types of access networks, such as, for example, a Wi-Fi® network, a local area network (LAN), a Citizens Broadband Radio System (CBRS) network, a cloud RAN, an O-RAN, a virtualized RAN (vRAN), a self-organizing network (SON), a wired network (e.g., optical, cable, etc.), or another type of network that provides access to or can be used as an on-ramp to access network 105.

Access network 105 may include different and multiple functional splitting, such as options 1, 2, 3, 4, 5, 6, 7, or 8 that relate to combinations of access network 105 and core network 120, or the splitting of the various layers (e.g., physical layer, media access control (MAC) layer, radio link control (RLC) layer, and packet data convergence protocol (PDCP) layer, etc.), plane splitting (e.g., user plane, control plane, etc.), interface splitting (e.g., F1-U, F1-C, E1, Xn-C, Xn-U, X2-C, Common Public Radio Interface (CPRI), etc.) as well as other types of network services, such as dual connectivity (DC) or higher (e.g., a secondary cell group (SCG) split bearer service, a master cell group (MCG) split bearer, an SCG bearer service, non-standalone (NSA), standalone (SA), etc.), carrier aggregation (CA) (e.g., intra-band, inter-band, contiguous, non-contiguous, etc.), edge and core network slicing, coordinated multipoint (CoMP), various duplex schemes (e.g., frequency division duplex (FDD), time division duplex (TDD), half-duplex FDD (H-FDD), etc.), and/or another type of connectivity service (e.g., NSA, NR, SA NR, etc.). Additionally, or alternatively, according to some exemplary embodiments, access network 105 may be implemented to include various wired and/or optical architectures for wired and/or optical access services.

Depending on the implementation, access network 105 may include one or multiple types of network devices, such as access devices 107. For example, access device 107 may include a next generation Node B (gNB), an enhanced LTE (eLTE) evolved Node B (eNB), an eNB, a radio network controller (RNC), a radio intelligent controller (RIC), a base station (BS), a base station controller (BSC), a remote radio head (RRH), a baseband unit (BBU), a radio unit (RU), a remote radio unit (RRU), a centralized unit (CU), a CU-control plane (CP), a CU-user plane (UP), a distributed unit (DU), a small cell node (e.g., a picocell device, a femtocell device, a microcell device, a home eNB, a home gNB, etc.), an open network device (e.g., O-RAN Centralized Unit (O-CU), O-RAN Distributed Unit (O-DU), O-RAN next generation Node B (O-gNB), O-RAN evolved Node B (O-eNB)), a 5G ultra-wide band (UWB) node, a future generation wireless access device (e.g., a 5G advanced wireless station, a 6G wireless station, a 7G wireless station, or another generation of wireless station), or another type of cellular wireless station. Access devices 107 may also include a network device that provides a transport service (e.g., routing and forwarding), such as a router, a switch, or another type of layer 3 (e.g., network layer of the Open Systems Interconnection (OSI) model) network device.

According to some exemplary implementations, access device 107 may include a combined functionality of multiple radio access technologies (RATs) (e.g., 4G and 5G functionality, 5G and 5G Advanced functionality, 5G and 6G), etc.) via soft and hard bonding based on demands and needs. According to some exemplary implementations, access device 107 may include a split access device (e.g., a CU-control plane (CP), a CU-user plane (UP), etc.) or an integrated functionality, such as a CU-CP and a CU-UP, or other integrations of split RAN nodes. Access device 107 may be an indoor device or an outdoor device.

External network 115 may include one or multiple networks of one or multiple types and technologies that provide an application service. For example, external network 115 may be implemented using one or multiple technologies including, for example, network function virtualization (NFV), software defined networking (SDN), cloud computing, Infrastructure-as-a-Service (IaaS), Platform-as-a-Service (PaaS), Software-as-a-Service (SaaS), or another type of network technology. External network 115 may be implemented to include a cloud network, a private network, a public network, a multi-access edge computing (MEC) network, a fog network, the Internet, a packet data network (PDN), a service provider network, the World Wide Web (WWW), an IP Multimedia System (IMS) network, a Rich Communication Service (RCS) network, a software defined (SD) network, a virtual network, a packet-switched network, a data center, or other type of network that may provide access to and may host an end device application service or a network application service.

Depending on the implementation, external network 115 may include various network devices such as external devices 117. For example, external devices 117 may include virtual network devices (e.g., virtualized network functions (VNFs), servers, host devices, containers, hypervisors, virtual machines (VMs), network function virtualization infrastructure (NFVI), and/or other types of virtualization elements, layers, hardware resources, operating systems, engines, etc.) that may be associated with application services for use by end devices (not illustrated). By way of further example, external devices 117 may include mass storage devices, data center devices, NFV devices, SDN devices, cloud computing devices, platforms, and other types of network devices pertaining to various network-related functions, as described herein. External network 115 may include one or multiple types of core devices 122, as described herein.

External devices 117 may host one or multiple types of application services. For example, the application services may pertain to broadband services in dense areas (e.g., pervasive video, smart office, operator cloud services, video/photo sharing, etc.), broadband access everywhere (e.g., ultra-low-cost network, etc.), enhanced mobile broadband (eMBB), higher user mobility (e.g., high speed train, remote computing, moving hot spots, etc.), Internet of Things (IoT) services (e.g., smart wearables, sensors, mobile video surveillance, smart cities, connected home, massive IoT (mIoT), critical IoT (cIoT), etc.), extreme real-time communications (e.g., tactile Internet, augmented reality (AR), virtual reality (VR), eXtended reality (XR), mixed reality (MR), etc.), lifeline communications (e.g., natural disaster, emergency response, etc.), ultra-reliable communications (e.g., automated traffic control and driving, collaborative robots, health-related services (e.g., monitoring, remote surgery, etc.), drone delivery, public safety, etc.), broadcast-like services, communication services (e.g., email, text (e.g., Short Messaging Service (SMS), Multimedia Messaging Service (MMS), etc.), massive machine-type communications (mMTC), voice, conferencing, instant messaging), video streaming, gaming (e.g., cloud gaming (CG), etc.), and/or other types of wireless and/or wired application services.

External devices 117 may also include other types of network devices that support the operation of external network 115 and/or the provisioning of application services, such as an orchestrator, an edge manager, an operations support system (OSS), a local domain name system (DNS), registries, a gateway, and/or external devices 117 that may pertain to various network-related functions or services (e.g., security, management, charging, billing, authentication, authorization, policy enforcement, development, communication with other networks, etc.). External devices 117 may include non-virtual, logical, and/or physical network devices.

Core network 120 may include one or multiple networks of one or multiple network types and technologies. Core network 120 may include a complementary network of access network 105. For example, core network 120 may be implemented to include a 5G core network, an evolved packet core (EPC) of an LTE network, a future generation core network (e.g., a 5G Advanced, a 6G, a 7G, or another generation of core network), and/or another type of core network.

Depending on the implementation of core network 120, core network 120 may include diverse types of network devices that are illustrated in FIG. 1 as core devices 122. For example, core devices 122 may include a user plane function (UPF), a Non-3GPP Interworking Function (N3IWF), an access and mobility management function (AMF), a session management function (SMF), a unified data management (UDM) device, a unified data repository (UDR), an authentication server function (AUSF), a network slice selection function (NSSF), a network repository function (NRF), a policy control function (PCF), a network data analytics function (NWDAF), a network exposure function (NEF), a service communication proxy (SCP), a Time Sensitive Communication and Time Sensitive Function (TSCTCF), a future generation core device (e.g., a 5G-Advanced core device, a 6G core device, a 7G core device, etc.), a service capability exposure function (SCEF), a lifecycle management (LCM) device, an application function (AF), a mobility management entity (MME), a packet gateway (PGW), an enhanced packet data gateway (ePDG), a serving gateway (SGW), a home agent (HA), a General Packet Radio Service (GPRS) support node (GGSN), a home subscriber server (HSS), an authentication, authorization, and accounting (AAA) server, a policy and charging rules function (PCRF), a policy and charging enforcement function (PCEF), and a charging system (CS), or a sub-combination thereof. Additionally, core devices 122 may include transport devices (e.g., routers or the like), and a transport control device, such as a path computation engine (PCE).

According to other exemplary implementations, core devices 122 may include additional, different, and/or fewer network devices than those described. For example, core devices 122 may include a non-standard or a proprietary network device, and/or another type of network device that may be well-known but not particularly mentioned herein. Core devices 122 may also include a network device that provides a multi-generation functionality (e.g., 4G and 5G, 5G and 5G Advanced, 5G and 6G, etc.), such as an SMF with PGW control plane functionality (e.g., SMF+PGW-C), a UPF with PGW user plane functionality (e.g., UPF+PGW-U), and/or other types of combined nodes (e.g., an HSS with a UDM and/or UDR, an MME with an AMF, etc.). Also, core devices 122 may include a split core device 122. For example, core devices 122 may include a session management (SM) PCF, an access management (AM) PCF, a user equipment (UE) PCF, and/or another type of split architecture associated with another core device 122, as described herein.

According to an exemplary embodiment, at least some of core devices 122 include logic of an exemplary embodiment of the service profile event configuration service, as described herein. For example, such core devices 122 may include logic that executes a network procedure, a function, a feature, or a service according to a service profile, as described herein. According to an exemplary embodiment, the service profile may be included in a user subscription profile pertaining to end device 130 and/or a user of end device 130. For example, the service profile may include one or multiple SPEC identifiers that correlates to a particular data instance or category of data included in the user subscription profile, as described herein.

End device 130 includes a device that may have communication capabilities (e.g., wireless, wired, optical, etc.). End device 130 may or may not have computational capabilities. End device 130 may be implemented as a mobile device, a portable device, a stationary device (e.g., a non-mobile device or a non-portable device), a device operated by a user, or a device not operated by a user. For example, end device 130 may be implemented as a smartphone, a mobile phone, a personal digital assistant, a tablet, a netbook, a wearable device (e.g., a watch, glasses, etc.), a computer (e.g., laptop, palmtop, etc.), a gaming device, a music device, an IoT device, a drone, a smart device, a television, a set top box, a media player or streaming device, a telematics device, or another type of wireless device (e.g., another type of UE). End device 130 may be configured to execute various types of software (e.g., applications, programs, etc.) that enable access and use of various application services, as described herein. The number and the types of software may vary among end devices 130. End devices 130 may include “edge-aware” and/or “edge-unaware” application service clients. For purposes of description, end device 130 is not considered a network device.

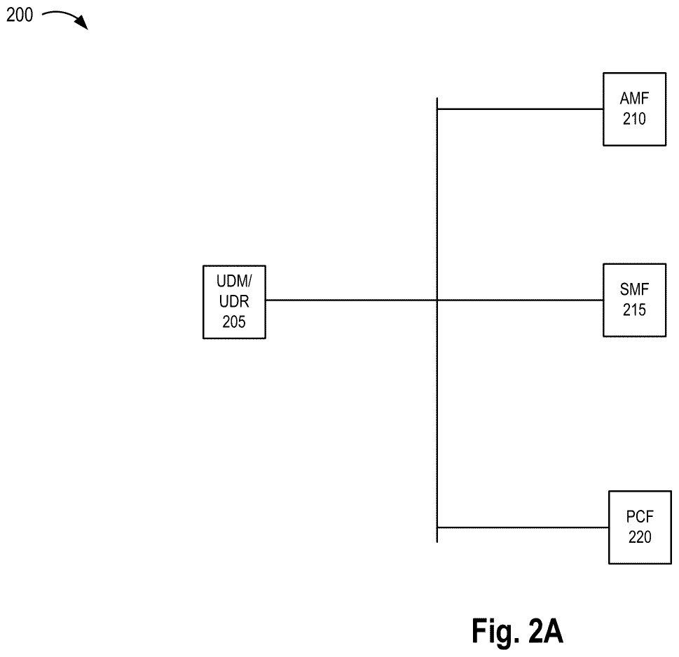

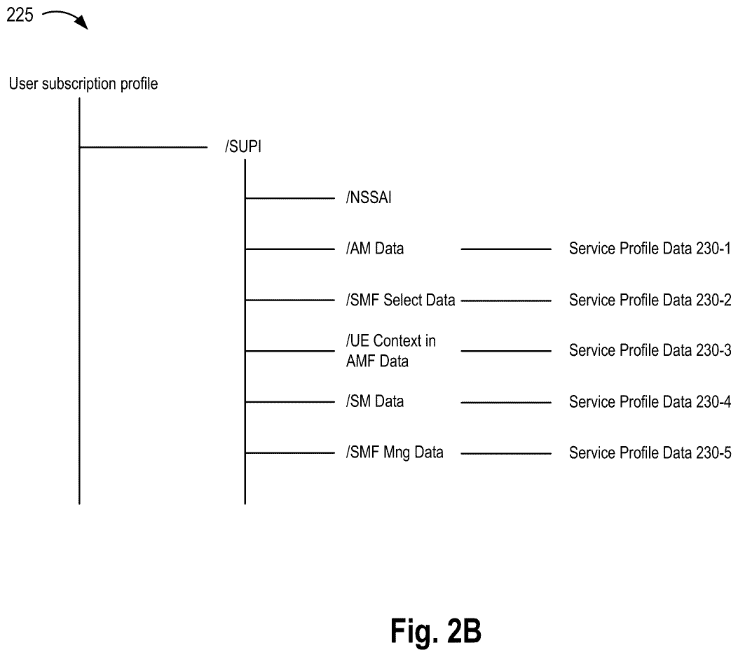

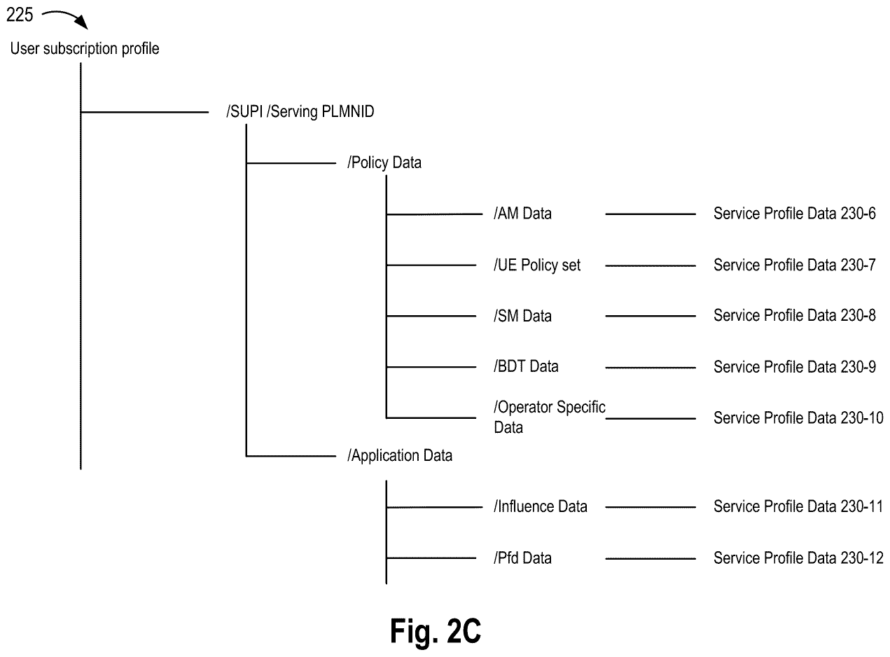

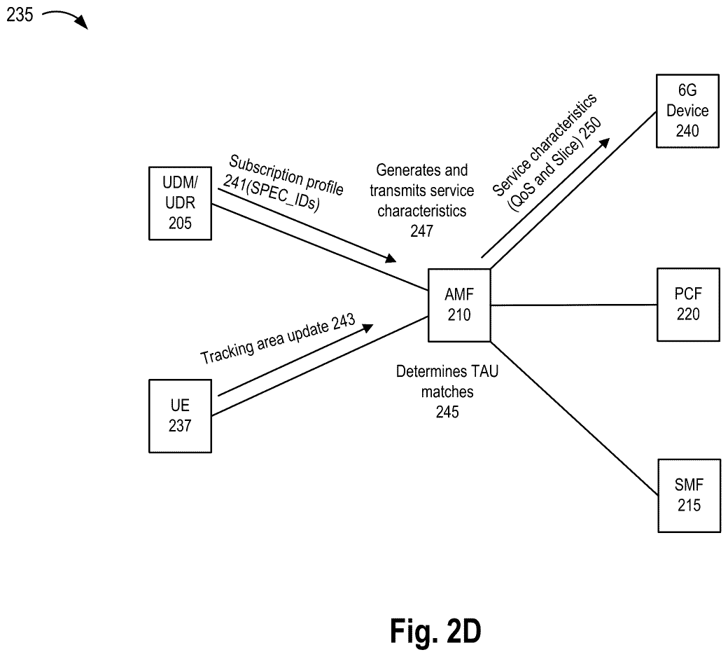

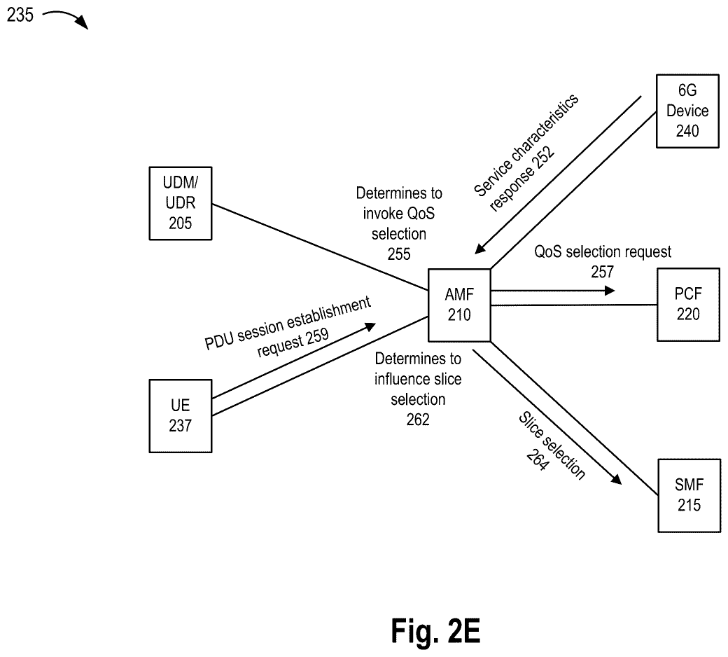

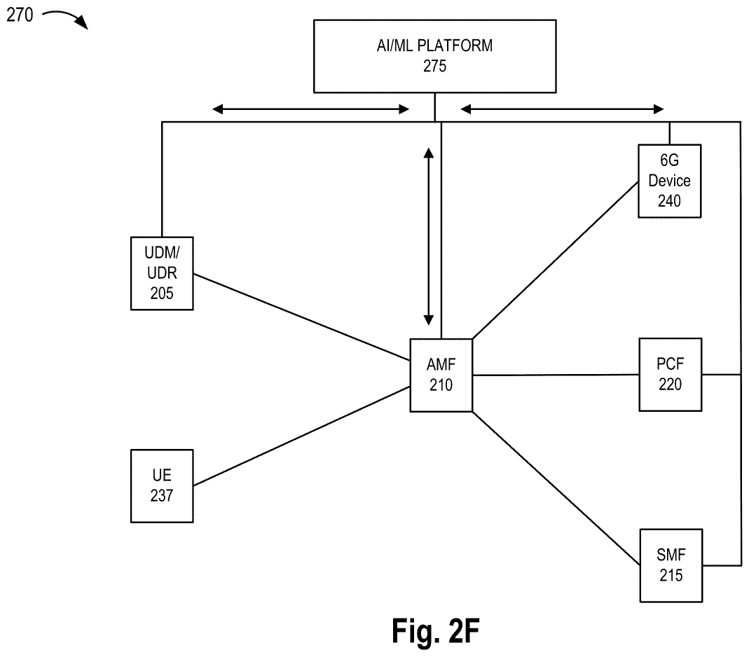

FIG. 2A is a diagram illustrating an exemplary environment 200 of an exemplary embodiment of the service profile event configuration service. As illustrated, environment 200 may involve exemplary network devices, such as a UDM/UDR 205, an AMF 210, an SMF 215, and a PCF 220. UDM/UDR 205, AMF 210, SMF 215, and PCF 220 are each an exemplary implementation of core device 122 that provides or supports the service profile event configuration service. According to other exemplary environments, different, additional, or fewer core devices 122 may be implemented with the service profile event configuration service. The connections between UDM/UDR 205, AMF 210, SMF 215, and PCF 220 are exemplary.

UDM/UDR 205, AMF 210, SMF 215, and PCF 220 may each include logic that performs an operation or provides a function that is in accordance with a technical specification associated with a network standardizing body, such as 3GPP, 3GPP2, ITU, ETSI, GSMA, or the like.

According to an exemplary embodiment, UDM/UDR 205, AMF 210, SMF 215, and PCF 220 may each include logic of the service profile event configuration service, as described herein. For example, UDM/UDR 205 may store service profiles correlated to different data instances and/or categories of data included in user subscription profiles. An exemplary user subscription profile is illustrated and described for purposes of description, as set forth below. While a UDM may store and manage different data than a UDR, the user subscription profile is described in an integrated manner for purposes of brevity. For example, the UDM may store and manage user-related data and subscription information and the UDR may store and manage other user-related data including application-specific data, policy information, and user profiles.

Referring to FIGS. 2B and 2C, a user subscription profile 225 may include different data categories and data instances, which may include types of data associated with a network standard, operator specific data, and so forth. For example, referring to FIG. 2B, user subscription profile 225 may include network slice selection assistance information (NSSAI), access and mobility management (AM) data, SMF selection data, UE context in AMF data, SM data, and SMF management data. Referring to FIG. 2C, user subscription profile 225 may include policy data, which may include AM data, UE policy set, SM data, Background Data Transfer (BDT) data, and operator specific data. Additionally, user subscription profile 225 may further include application data, which may include influence data and Packet Flow Description (PFD) data. As further illustrated in FIGS. 2B and 2C, the exemplary data included in user subscription profile 225 may include correlated service profile data 230-1 through 230-12 (also referred to as service profiles 230 or individually or generally as service profile 230).

According to various exemplary embodiments, the schema for service profile data 230 may be different. For example, according to an exemplary embodiment, service profile 230 may include data indicating a SPEC identifier (e.g., SPEC_ID 1001, SPEC_ID 1002, etc.). The SPEC identifier may indicate a network procedure, one or more steps of a process or service, a feature, or the like, as described herein. For example, referring to FIG. 2B and AM data, service profile 230-1 may include the exemplary data:
Spec={1001, 1002, . . . n}
   According to an exemplary embodiment, the SPEC identifier may identify logic (e.g., a script, software, applet, program, plug-in, object, executable file, etc., as described herein), that may be used to carry out the pluggable service.

According to another example, service profile 230 may include a different schema, examples of which are provided below along with further description:
1) SPEC_ID 1001={event=Geofencing}+6G Sensing NF+{QoS, slice}
2) SPEC_ID 1002={event=Geofencing}+6G Sensing NF+{QoS, slice}+Looped SPEC ((1003, priority=100), (1004, priority=300))
3) SPEC_ID 1003={event=On Success (1002)}+PCF+{QoS selection}
4) SPEC_ID 1004={event=PDU Session Setup Request Arrival in AMF}
5) SPEC_ID 1005={event=PDU Session Setup Request Processing in SMF-QoS Failure}
6) SPEC_ID 1006={event=Registration−Ready to Invoke UE-PCF in AMF}

According to this different schema, service profile 230 may include not only a SPEC identifier but a composition of the new service or feature. According to an exemplary embodiment, the composition of the SPEC identifier, which may identify the new or enhanced service or feature, may include an event or trigger condition, routing data, service characteristics, and a looped SPEC, which may indicate multiple SPEC identifiers and priority values. Alternatively, service profile 230 may include a subset of these data instances. For example, as shown in example (1), SPEC_ID 1001 may specify an event, routing data, and service characteristics data. By way of further example, SPEC_ID 1001 may be part of the AM data of FIG. 2B, which may be triggered when a UE is in a configured Tracking Area Code (TAC). Once the event is triggered, AMF 210 may define the service characteristics (e.g., QoS and network slice information), and may route this information to a 6G network device.

Referring to example (2), SPEC_ID 1002 may also be a part of the AM data of FIG. 2B, which may be triggered when a UE is in a configured Tracking Area Code (TAC). Once the event is triggered, AMF 210 may define the service characteristics (e.g., QoS and network slice information), and may route this information to a 6G network device. Additionally, AMF 210 may wait for a successful response from the 6G network device. Upon receiving the successful response, AMF 210 may trigger the looped SPEC with the highest priority value. For example, as set forth above, the looped SPEC may include arguments, such as a SPEC identifier (e.g., 1003, 1004) and a priority value (e.g., 100, 300). For example, a lower priority value may indicate a higher priority or vice versa.

Referring to example (3), SPEC_ID 1003 may be triggered by AMF 210 upon successful execution of SPEC_ID 1002 regarding the service characteristic and includes AMF 210 requesting from PCF 220 for QoS selection. Referring to example, (4), SPEC_ID 1004 may include influencing the network slice to be selected in accordance with the specified event. Referring to example (5), SPEC_ID 1005 may include invoking a new service to manage a QoS failure event, as specified therein. Referring to example (6), SPEC_ID 1006 may be triggered when, during a registration procedure, AMF 210 is ready to invoke a UE-PCF, but for this specific subscriber, the new feature may include AMF 210 may avoid invoking the UE-PCF.

Referring back to FIG. 2A, AMF 210, SMF 215, and PCF 220 may obtain certain portions of user subscription profile 225, which includes service profiles 230, according to various network procedures, messaging, signal flows, etc., associated with a network standard, such as a registration procedure, a PDU session establishment procedure, a policy association procedure (e.g., SM policy association establishment, AM policy association establishment, etc.), and so forth.

According to an exemplary embodiment, the logic of the service profile event configuration service for AMF 210, SMF 215, and PCF 220 may include identifying an event, mapping the event to a SPEC identifier, and performing the new service or feature based on the SPEC identifier or a component of the SPEC. According to an exemplary implementation, when the exemplary schema indicates only a SPEC identifier, core device 122 may include an executable workflow or the like that carries out the pluggable new service or feature. According to another exemplary implementation, when the exemplary schema indicates the SPEC identifier and the components thereof, core device 122 may include logic that interprets and executes the components associated with the SPEC identifier. According to various exemplary embodiments, the logic of the service profile event configuration service may be implemented to include software, scripts, applets, programs, plug-ins, objects or the like (e.g., another form of an executable file, object code, set of instructions, package, function, etc.), or some combination thereof. According to an exemplary embodiment, the logic of the service profile event configuration service may interface and interact with the underlying core network device functionality in support of the new service or feature, as described herein.

FIGS. 2D and 2E illustrate an exemplary process 235 of an exemplary embodiment of the service profile event configuration service according to an exemplary scenario. Referring to FIG. 2D, in addition to UDM/UDR 205, AMF 210, SMF 215, and PCF 220, an exemplary environment may further include a UE 237 and a 6G core device 240. UE 237 may be an exemplary implementation of end device 130. 6G core device 240 may be a 6G core device, such as a sensing function.

Referring to FIG. 2D, AMF 210 may obtain a subscription profile 241 pertaining to UE 237 from UDM/UDR 205. As illustrated, subscription profile 241 may include service profiles, such as SPEC identifiers. For example, AMF 210 may obtain subscription profile 241 during a registration procedure relating to UE 237. Thereafter, AMF 210 may receive a tracking area update (TAU) 243 from UE 237. According to this exemplary scenario, assume that the SPEC identifiers include SPEC_ID 1002, as previously described. In response to receiving and reading TAU 243, AMF 210 may determine that the TAU matches 245 the (Geofencing) event, and in response generates and transmits service characteristics 247 to 6G device 240. For example, a service characteristics message 250 may include QoS and network slice information, as illustrated in FIG. 2D. The SPEC_ID 1002 may identify 6G device 240 and may include necessary communication information (e.g., network address, port, etc.) for AMF 210 to communicate with 6G device 240.

Referring to FIGS. 2E, 6G device 240 may transmit a successful response 252 to AMF 210. According to this exemplary scenario, assume that the SPEC identifiers include SPEC_ID 1003, as previously described. In response to receiving and reading response 252, AMF 210 may invoke the service associated with SPEC identifier 1003, as described herein. For example, AMF 210 may determine to invoke QoS selection by PCF 220. AMF 210 may generate and transmit a QoS selection request 257 to PCF 220.

Thereafter, AMF 210 may receive a PDU session establishment request 259 from UE 237. According to this exemplary scenario, assume that the SPEC identifiers include SPEC_ID 1004, as previously described. In response to receiving and reading request 259, AMF 210 may determine to influence slice selection 262. For example, AMF 210 may select a network slice. As further illustrated in process 235, AMF 210 may generate and transmit a network slice selection 264 to SMF 215.

FIGS. 2D and 2E are diagrams illustrating exemplary steps and messaging regarding exemplary pluggable services or features provided by an exemplary embodiment of the service profile event configuration service. According to other exemplary scenarios and service profiles, process 235 may include additional, different, or fewer steps and messaging.

As previously described, according to another exemplary embodiment the service profile event configuration service may enable pluggable features for various network devices based on a centralized AI driven service logic. For example, as a modification to the environment described in relation to process 235, an exemplary environment 270 may further include an AI/ML platform 275. AI/ML platform 275 may be connected to core devices 122, such as UDM/UDR 205, AMF 210, SMF 215, PCF 220, and 6G device 240 in support of the service profile event configuration service, as described herein.

AI/ML platform 275 may include an AI/ML model that may provide or support the service profile event configuration service, as described herein. According to an exemplary embodiment, the AI/ML model may be implemented as a neural network model (NNM), a Generalized Linear Model (GLM), a Decision Tree, or another type of learning-based algorithm. According to an exemplary embodiment, the service profile event configuration service may use an optimization algorithm, such as a reinforcement learning algorithm or another type of learning algorithm (e.g., supervised learning, etc.). The goal of the optimization may be configurable. For example, the optimization may relate to various network procedures to which the new feature or service pertains.

According to an exemplary embodiment, AI/ML platform 275 may command or direct core devices 122, such as AMF 210, SMF 215, PCF 220, etc., to perform the new service or feature in response to various events. For example, referring back to the exemplary scenario of FIG. 2D, AMF 210 may receive a TAU from UE 237. AMF 210 may forward the TAU to AI/ML platform 275, and in turn, AI/ML platform 275 may determine whether a new service is applicable or not, and if so, command AMF 210 to perform one or multiple operations of the new service or feature. In this way, AI/ML platform 275 may manage the execution of the new service, which may involve multiple core devices 122, in a centralized manner. According to such an exemplary embodiment, AMF 210 may operate as a dumb core device 122 relative to the new service. According to various exemplary embodiments, AMF 210 may or may not include an interface (e.g., an AI/ML client, an AI/ML agent, etc.) that may communicate with AI/ML platform 275.

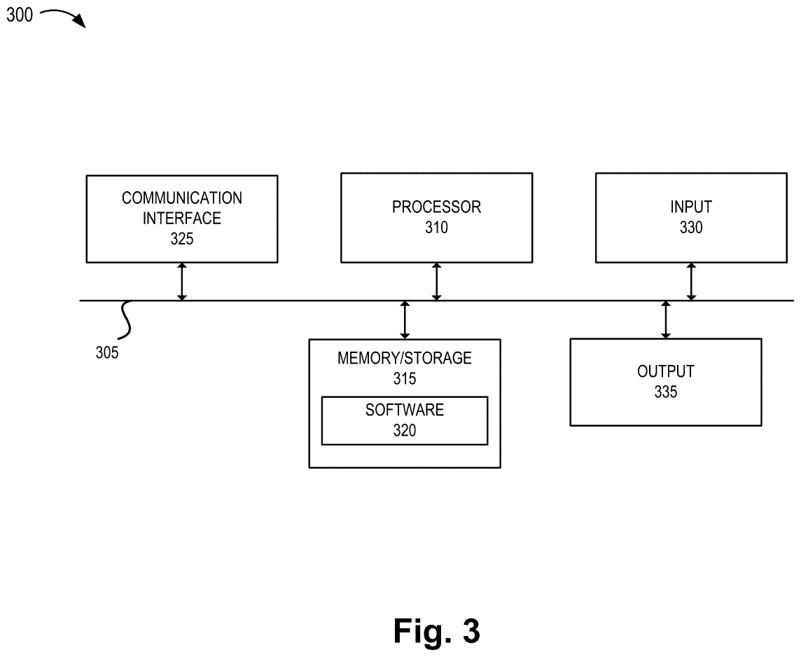

FIG. 3 is a diagram illustrating exemplary components of a device that may correspond to one or more of the devices illustrated and described herein. For example, device 300 may correspond to access device 107, external device 117, core device 122, end device 130, and/or other types of devices, as described herein. As illustrated in FIG. 3, device 300 includes a bus 305, a processor 310, a memory/storage 315 that stores software 320, a communication interface 325, an input 330, and an output 335. According to other embodiments, device 300 may include fewer components, additional components, different components, and/or a different arrangement of components than those illustrated in FIG. 3 and described herein.

Bus 305 includes a path that permits communication among the components of device 300. For example, bus 305 may include a system bus, an address bus, a data bus, and/or a control bus. Bus 305 may also include bus drivers, bus arbiters, bus interfaces, clocks, and so forth.

Processor 310 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), quantum processors, future generation processors or execution environments, and/or some other type of component that interprets and/or executes instructions and/or data. Processor 310 may be implemented as hardware (e.g., a microprocessor, etc.), a combination of hardware and software (e.g., a SoC, an ASIC, etc.), may include one or multiple memories (e.g., cache, etc.), etc.

Processor 310 may control the overall operation, or a portion of operation(s) performed by device 300. Processor 310 may perform one or multiple operations based on an operating system and/or various applications or computer programs (e.g., software 320). Processor 310 may access instructions from memory/storage 315, from other components of device 300, and/or from a source external to device 300 (e.g., a network, another device, etc.). Processor 310 may perform an operation and/or a process based on various techniques and/or technologies including, for example, multithreading, parallel processing, pipelining, interleaving, machine learning, artificial intelligence, etc.

Memory/storage 315 includes one or multiple memories and/or one or multiple other types of storage mediums. For example, memory/storage 315 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory (e.g., 2D, 3D, NOR, NAND, etc.), a solid state memory, and/or some other type of memory. Memory/storage 315 may include a hard disk (e.g., a magnetic disk, an optical disk, a magneto-optic disk, a solid-state component, etc.), a Micro-Electromechanical System (MEMS)-based storage medium, and/or a nanotechnology-based storage medium.

Memory/storage 315 may be external to and/or removable from device 300, such as, for example, a Universal Serial Bus (USB) memory stick, a dongle, a hard disk, a solid state drive, mass storage, off-line storage, cloud storage, or some other type of storing medium. Memory/storage 315 may store data, software, and/or instructions related to the operation of device 300.

Software 320 includes an application or a program that provides a function and/or a process. As an example, with reference to core device 122, software 320 may include an application that, when executed by processor 310, provides a function and/or a process of service profile event configuration service, as described herein. According to another example, with reference to AI/ML platform 275, software 320 may include an application that, when executed by processor 310, provides a function and/or a process of service profile event configuration service, as described herein. Software 320 may also include firmware, middleware, microcode, hardware description language (HDL), and/or other form of instruction. Software 320 may also be virtualized. Software 320 may further include an operating system.

Communication interface 325 permits device 300 to communicate with other devices, networks, systems, and/or the like. Communication interface 325 includes one or multiple wireless interfaces, optical interfaces, and/or wired interfaces. For example, communication interface 325 may include one or multiple transmitters and receivers, or transceivers. Communication interface 325 may operate according to a protocol stack and a communication standard.

Input 330 permits an input into device 300. For example, input 330 may include a keyboard, a mouse, a display, a touchscreen, a touchless screen, a button, a switch, an input port, a joystick, speech recognition logic, and/or some other type of visual, auditory, tactile, affective, olfactory, etc., input component. Output 335 permits an output from device 300. For example, output 335 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, PaaS, etc.). Device 300 may be implemented in the same manner. For example, device 300 may be instantiated, created, spun-up, uninstantiated, deleted, spun-down, or some other operational state during its life cycle (e.g., refreshed, paused, suspended, rebooting, or another type of state or status), using well-known virtualization technologies. For example, access device 107, core device 122, external device 117, and/or another type of network device or end device 130, as described herein, may be a virtualized device.

Device 300 may perform a process and/or a function, as described herein, in response to processor 310 executing software 320 stored by memory/storage 315. By way of example, instructions may be read into memory/storage 315 from another memory/storage 315 (not shown) or read from another device (not shown) via communication interface 325. The instructions that are stored by memory/storage 315 may configure and cause processor 310 to perform a function or a process described herein. Alternatively, for example, according to other implementations, device 300 performs a function or a process described herein based on the execution of hardware (processor 310, etc.).

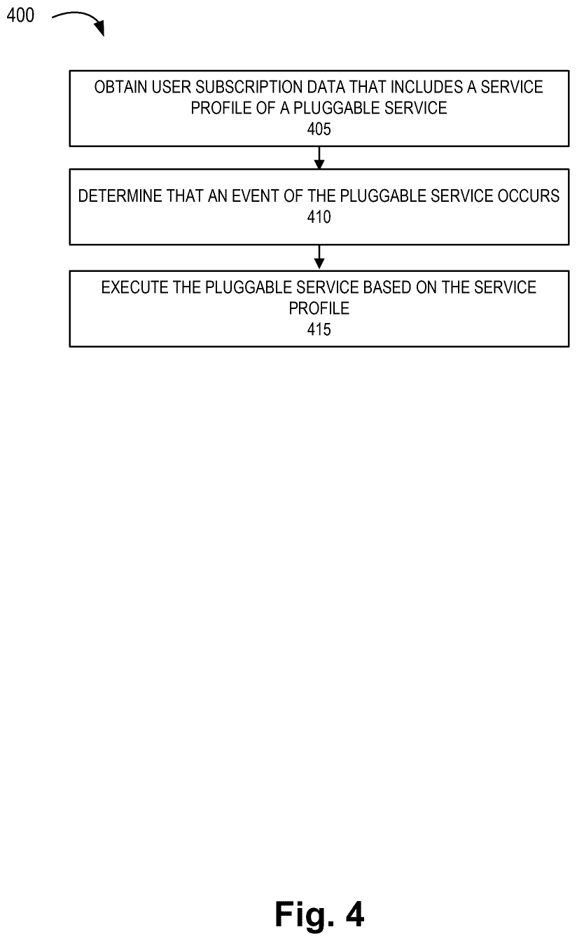

FIG. 4 is a flow diagram illustrating an exemplary process 400 of an exemplary embodiment of the service profile event configuration service. According to an exemplary embodiment, core device 122, as described herein, may perform a step of process 400. According to an exemplary implementation, processor 310 executes software 320 to perform a step of process 400, as described herein. Alternatively, a step may be performed by execution of only hardware.

In block 405, core device 122 may obtain user subscription data that includes a service profile of a pluggable service. For example, core device 122 may obtain the user subscription data according to various network procedures, such as a registration procedure of end device 130, an establishment of a PDU session or other type of application service session, or other known network procedure to which core device 122 obtains user subscription data from another core device 122, such as a UDM, a UDR, or future generation core device having similar functionality.

According to various exemplary embodiments, the service profile may be implemented with different schema or structure, as described herein. For example, the service profile may include one or multiple SPEC identifiers that correlate to user subscription data instance or category of user subscription data, as described herein. The SPEC identifier may identify a pluggable and executable workflow or network procedure of the pluggable service that core device 122 may be enabled to perform. According to other examples, the service profile may specify an event or trigger condition, routing data, service characteristics, and a looped SPEC, which may indicate multiple SPEC identifiers and priority values, or a subset of these data instances, as described herein, which may enable core device 122 to execute or perform.

According to an exemplary embodiment, the pluggable service may be a service enhancement relative to an essential or standardized functionality associated with core device 122.

In block 410, core device 122 may determine that an event of the pluggable service occurs. For example, core device 122 may receive and process a message from another core device 122, end device 130, external device 117, or access device 107 that is attributable to the execution of the pluggable service relative to end device 130 and/or the user of end device 130 associated with the user subscription data.

In block 415, core device 122 may execute the pluggable service based on the service profile. For example, core device 122 may perform a network procedure of the pluggable service according to the service profile event configuration information included in the service profile and logic configured at core device 122.

FIG. 4 illustrates an exemplary process 400 of the service profile event configuration service, according to other exemplary embodiments, the service profile event configuration service may perform additional operations, fewer operations, and/or different operations than those illustrated and described. For example, core device 122 may determine the occurrence of the event during the execution of the pluggable service, such as during the execution of a chained pluggable service.

As set forth in this description and illustrated by the drawings, reference is made to “an exemplary embodiment,” “exemplary embodiments,” “an embodiment,” “embodiments,” etc., which may include a particular feature, structure, or characteristic in connection with an embodiment(s). However, the use of the phrase or term “an embodiment,” “embodiments,” etc., in various places in the description does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. For example, although examples of the service profile event configuration service have been provided regarding core devices 122, the service may be implemented for access devices 107 of a RAN, for example. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” The term “substantially” is used herein to represent a degree by which a quantitative representation may vary from a stated reference without resulting in a change in the basic function of the subject matter at issue.

Any embodiment or implementation described as “exemplary” is not necessarily to be construed as preferred or advantageous over other embodiments or implementations.

In addition, while a series of blocks has been described regarding the process illustrated in FIG. 4, the order of the blocks may be modified according to other embodiments. Further, non-dependent blocks may be performed in parallel. Additionally, other processes described in this description and illustrated in the drawings may be modified and/or non-dependent operations may be performed in parallel.

Embodiments described herein may be implemented in many different forms of software executed by hardware. For example, a process or a function may be implemented as “logic” or a “component.” The logic or the component may include, for example, hardware (e.g., processor 310, etc.), or a combination of hardware and software (e.g., software 320).

Embodiments have been described without reference to the specific software code because the software code can be designed to implement the embodiments based on the description herein and commercially available software design environments and/or languages. For example, diverse types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 310) of a device. A non-transitory storage medium includes one or more of the storage mediums described in relation to memory/storage 315. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to the consent of the individual to such activity, for example, through well known “opt-in” or “opt-out” processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later become known are expressly incorporated herein by reference and are intended to be encompassed by the claims.

What is claimed is:

1. A method comprising:
obtaining, by a device, a user subscription profile that includes a service profile of a service;
determining, by the device, that a triggering event for the service occurs; and
executing, by the device, the service according to the service profile.

2. The method of claim 1, wherein the service profile includes data that specifies the triggering event.

3. The method of claim 1, wherein the service profile includes routing data and service characteristics data pertaining to the service.

4. The method of claim 1, wherein the service profile includes an identifier of the service, and wherein the method further comprises:
selecting, by the device based on the identifier, logic to perform the service.

5. The method of claim 1, wherein the service is a pluggable service that pertains to access, mobility, or session management associated with a user to which the user subscription profile pertains.

6. The method of claim 1, wherein the service profile correlates to a type of data included in the user subscription profile.

7. The method of claim 1, wherein the service profile includes looped data that calls other services with distinct priorities.

8. The method of claim 1, wherein the device is a Fifth Generation (5G) core device, a 5G advanced core device, or a Sixth Generation (6G) core device of a core network.

9. A device comprising:
a processor that is configured to:
obtain a user subscription profile that includes a service profile of a service;
determine that a triggering event for the service occurs; and
execute the service according to the service profile.

10. The device of claim 9, wherein the service profile includes data that specifies the triggering event.

11. The device of claim 9, wherein the service profile includes routing data and service characteristics data pertaining to the service.

12. The device of claim 9, wherein the service profile includes an identifier of the service, and wherein the processor is further configured to:
select, based on the identifier, logic to perform the service.

13. The device of claim 9, wherein the service is a pluggable service that pertains to access, mobility, or session management associated with a user to which the user subscription profile pertains.

14. The device of claim 9, wherein the service profile correlates to a type of data included in the user subscription profile.

15. The device of claim 9, wherein the service profile includes looped data that calls other services with distinct priorities.

16. The device of claim 9, wherein the device is a Fifth Generation (5G) core device, a 5G advanced core device, or a Sixth Generation (6G) core device of a core network.

17. A non-transitory computer-readable storage medium storing instructions executable by a processor of a device, wherein the instructions are configured to:
obtain a user subscription profile that includes a service profile of a service;
determine that a triggering event for the service occurs; and
execute the service according to the service profile.

18. The non-transitory computer-readable storage medium of claim 17, wherein the service profile includes routing data and service characteristics data pertaining to the service.

19. The non-transitory computer-readable storage medium of claim 17, wherein service is a pluggable service that pertains to access, mobility, or session management associated with a user to which the user subscription profile pertains.

20. The non-transitory computer-readable storage medium of claim 17, wherein the service profile includes an identifier of the service, and wherein the instructions comprise instructions configured to:
select, based on the identifier, logic to perform the service.
